(19) United States
(12) Patent Application Publication
(10) Pub. No.: US 2015/0280997 A1
(43) Pub. Date: Oct. 1, 2015

(54) SYSTEM AND METHOD FOR BINDING DEVICES USING NETWORK TOPOLOGIES

(71) Applicant: National Taiwan University, Taipei (TW)

(72) Inventors: CHUN-TING CHOU, Taipei City (TW); CHUN-YU CHEN, Tainan City (TW)

(73) Assignee: National Taiwan University, Taipei (TW)

(21) Appl. No.: 14/337,240

(22) Filed: Jul. 22, 2014

(30) Foreign Application Priority Data
Mar. 25, 2014 (TW) 103110961

(51) Int. Cl. H04L 12/24; G06F 3/0482; H04L 29/08; G06F 3/0484; G06F 3/0481

(52) U.S. Cl. CPC H04L 41/12; H04L 41/0816; H04L 41/0889; G06F 3/04842; G06F 3/04817; H04L 67/141; G06F 3/0482; H04L 41/22

(57) ABSTRACT

A system for binding a plurality of devices using network topologies includes one or more calculating units, a plurality of signal transmitting modules and a user interface. The calculating unit calculates a topology relation of the plurality of devices in physical space. The plurality of signal transmitting modules are separately disposed in the plurality of devices so that they can transmit and receive device data and the topology relation of the plurality of devices. The user interface includes a set of interface icon identifications corresponding to the devices, wherein the plurality of devices are individually or partly bound and connected by connecting the interface icon identifications in the user interface.

### BACKGROUND OF THE INVENTION

1. Field of the Invention

The present invention generally relates to a system and a method for binding devices, and more particularly to a system and a method for binding a plurality of devices in a user interface according to a topological relation in physical space.

2. Description of Related Art

At present, many devices could generate a binding relation with each other by manually selecting the device identifications of devices displayed on the screen, pushing buttons on the devices concurrently, or touching one device with near field communication (NFC) with another device with NFC to perform the associated actions, but there is a lot of inconvenience in the present binding method by the wired or wireless communication technology. As shown in FIG. 1A and FIG. 1B, which illustrate a flow diagram for binding devices according to the prior art and smart phones being connected by the Bluetooth connection technology. In this example, although the smart phones are illustrated as operating devices for the wireless connection by the Bluetooth connection technology, however the other devices and other wired or wireless communication methods might also be used and illustrated.

In step S02, the user must enter a setting selection of the smart phone to set a wireless network. In step S04, the user must activate a Bluetooth module of the smart phone to sense if there is any available device for the connection. In step S06, when the module senses some devices, the user must perform the selecting step in a pairing table for the connection, according to the identifications of the devices. As shown in FIG. 1B. FIG. 1B illustrates a view for two smart phones, identifications of which are John and Marry, being connected by the Bluetooth connection technology. If the smart phone John wants to establish a binding with the smart phone Marry, firstly the user of the smart phone John must confirm whether the identification of the other device is Mary or not, and the selecting action might then be performed. In step S08, two smart phones John and Marry are confirmed in the pairing table for the connection. Accordingly, the process of establishing the binding between the devices is performed by the above steps.

However, in step S06 mentioned above, when the user performs the process for connecting the devices, it is necessary for the user to confirm the identification of the other device, or otherwise the connecting action is unable to perform. Moreover, when the devices are connected in practice, the identifications of devices sensed in the pairing table are usually unknown or hardly recognized by the user. That is, as each displaying identification of the devices is defined by each user of the devices, thus it results that other users hardly recognize the devices, and it further causes inconvenience for the devices to be connected or paired.

In addition to the above problem for confirming the identifications of the devices in the connecting action, there are other problems causing inconvenience in the connection between the other devices. For example, if there are 100 lamps being disposed in the space and respectively controlled by 5 switches, the method of prior art would require manual pairing each lamp to a specific switch. That is, a user has to repeat 100 times of the pairing steps. Therefore, it would increase the pairing cost, manpower and time.

A need has thus arisen to propose a simple, fast, intuitive and flexible method for connecting devices, which may enable the user to operate each device in a faster and more convenient way.

### SUMMARY OF THE INVENTION

The present invention provides a system for binding a plurality of devices using network topologies in accordance with a topological relation of devices in physical space displayed in a user interface, so that the user may operate the icons in user interface for binding the devices in physical space. The system includes one or more calculating units, a plurality of signal transmitting modules and a user interface. The calculating unit is configured to calculate relative positions of a plurality of devices in physical space. The signal transmitting modules are separately disposed in the plurality of devices, so as to transmit and receive device data and the topological relation of the plurality of devices. The user interface includes a set of interface icon identifications corresponding to the plurality of devices. The plurality of devices are individually or partly bound and connected by connecting the interface icon identifications in the user interface

The present invention provides a method for binding a plurality of devices using network topologies, including the following steps: transmitting signals between the plurality of devices; calculating a topological relation of the plurality of devices in physical space according to the signals; displaying the plurality of devices in a user interface with a plurality of interface icon identifications based on their physical topology, wherein the plurality of interface icon identifications individually correspond to the plurality of devices; connecting the plurality of interface icon identifications in the user interface; transmitting connecting commands of the plurality of interface icon identifications to the corresponding devices; and binding the plurality of devices according to the received connecting commands.

In view of the foregoing, as for the method and system for binding a plurality of devices by using network topologies of the present invention, the devices are individually or partly bound and connected by the interface icon identifications in the user interface, which are corresponding to the topological relation of the devices in physical space. Compared with the prior art, which uses the identifications of devices for binding the devices, the present invention can allow the user to complete the connection and arrangement of devices in a convenient, fast and intuitive way. Further, as the user can change the connection and arrangement of devices, the connection generated in the user interface may have greater flexibility in the design, so as to further reduce the arrangement cost, manpower and time in physical space.

### BRIEF DESCRIPTION OF THE DRAWINGS

FIG. 1A is a flow diagram for binding devices according to the prior art;

FIG. 1B is a view illustrating smart phones being connected by a Bluetooth connection;

FIG. 2 is a flow diagram of a method for binding devices by using network topologies according to an embodiment of the present invention;

FIG. 3 illustrates a system for binding devices by using network topologies according to an embodiment of the present invention;

FIG. 4A to FIG. 4D illustrate views for binding devices by using network topologies according to an embodiment of the present invention;

FIG. 5A to FIG. 5G illustrate views for binding the devices of different types by using network topologies according to an embodiment of the present invention; and

FIG. 6A to FIG. 6E illustrate the views of the lamps being paired according to an embodiment of the present invention.

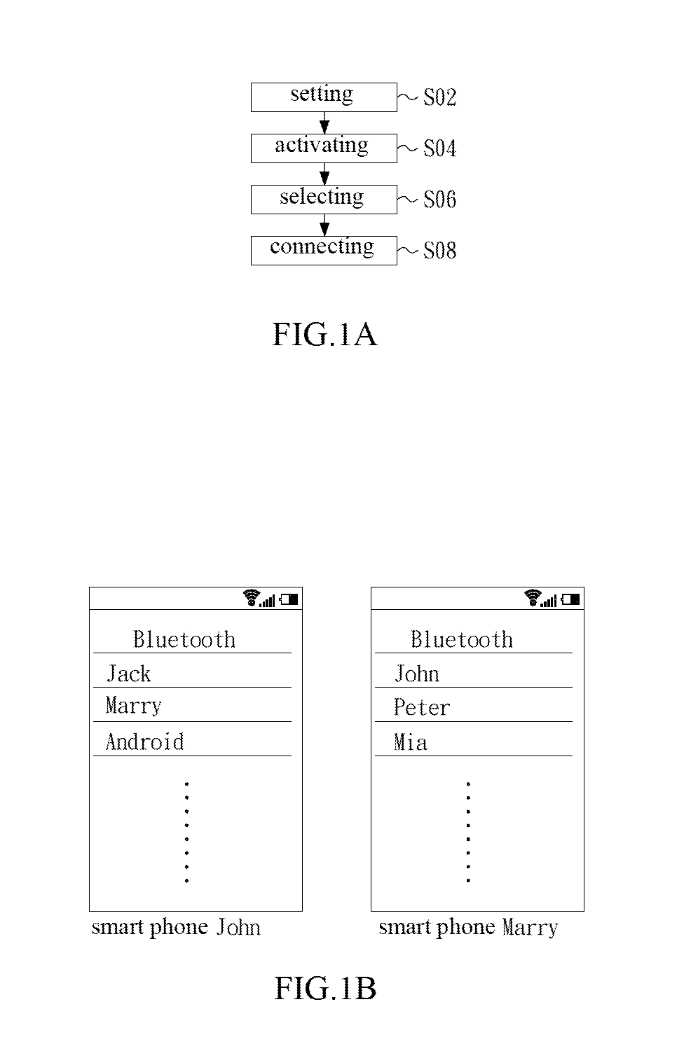

### DETAILED DESCRIPTION OF THE INVENTION

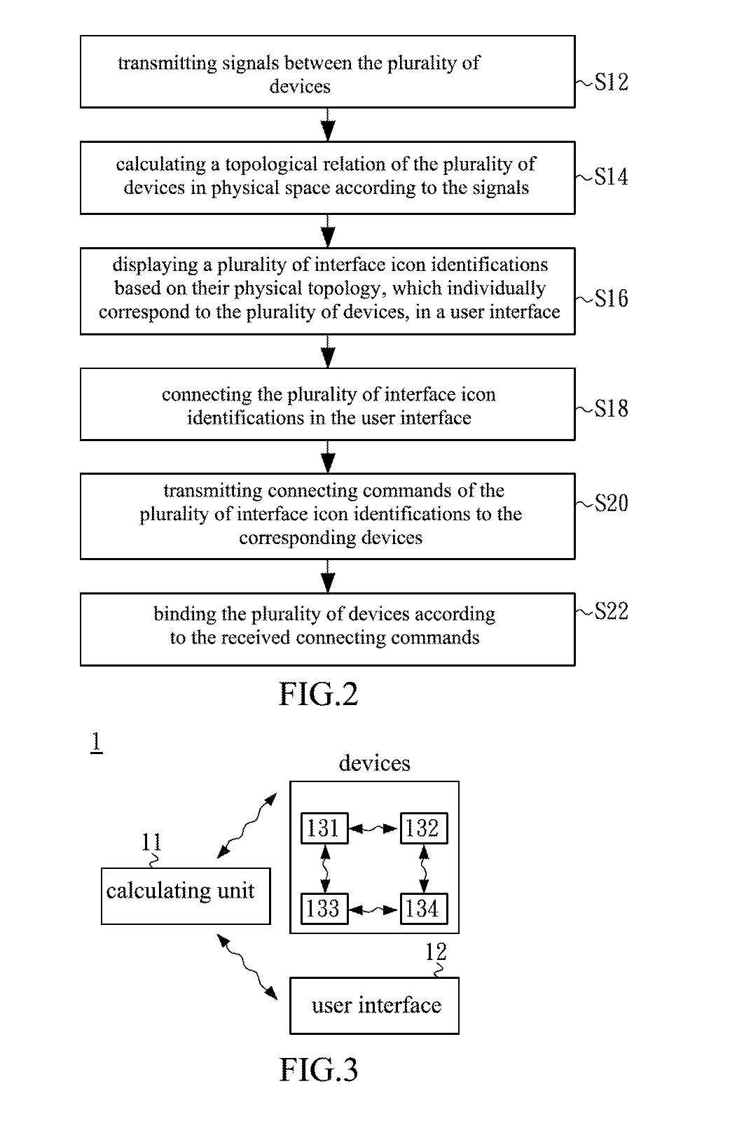

Referring to FIG. 2, FIG. 2 is a flow diagram of a method for binding a plurality of devices by using network topologies according to an embodiment of the present invention. The method includes the following steps: in step S12, transmitting signals between the plurality of devices; in step S14, calculating a topological relation of the plurality of devices in physical space according to the signals; in step S16, displaying a plurality of interface icon identifications based on their physical topology, which individually correspond to the plurality of devices, in a user interface; in step S18, connecting the plurality of interface icon identifications in the user interface; in step S20, transmitting connecting commands of the plurality of interface icon identifications to the corresponding devices; and in step S22, binding the plurality of devices according to the received connecting commands.

In view of the foregoing, in order to allow the user to quickly and easily bind the devices, in step S12, the devices must transmit signals with each other, so that the devices may make the reaction according to the received signals. Furthermore, in step S12, the steps of collecting and storing the signals are included, which may allow the user to bind the devices according to the collected or stored signals.

The signals are used to calculate relative positions of each device in physical space. The relative positions may be, for example, calculated by the received signal strength indictor (RSSI), the time of arrival (TOA), the time difference of arrival (TDOA) or the angle of arrival (AOA). Thus, the topological relation of the devices in physical space may be calculated. Furthermore, in one embodiment of the present invention, the topological relation may be calculated by a calculating unit.

Compared with the devices of the prior art, which use identifications of the devices for binding with each other, the method for binding a plurality of devices using network topologies of the present invention displays the arrangement of interface icon identifications, according a topological relation of devices in physical space. That is to say, the arrangement of the interface icon identifications in the user interface is the same as the topological relation of the devices in physical space.

Furthermore, the device data mentioned above includes a physical device identification (Hardware ID) or a network address. The method for binding a plurality of devices using network topologies of the present invention includes a step of recording the interface icon identifications and the physical device identifications in a look up table, and the interface icon identifications are corresponding to the physical device identifications.

In view of the foregoing, in step S18, the method for connecting the plurality of devices includes connecting or circling the interface icon identifications corresponding to the devices, so that the connected or circled interface icon identifications in the user interface may generate connecting commands. As the interface icon identifications are corresponding to the physical device identifications, the connecting commands can be transmitted to the corresponding devices by a signal transmitting module according to the interface icon identification and the physical device identification recorded in the look up table, once the connecting command is generated. Thus, the device may bind the other devices according to the received connecting commands.

Referring to FIG. 3, FIG. 3 illustrates a system for binding devices by using network topologies according to an embodiment of the present invention. The system for binding a plurality of devices using network topologies includes one or more calculating units 11, a plurality of signal transmitting modules (not illustrated) and a user interface 12. One or more calculating units are configured to calculate a topological relation of a plurality of devices 131, 132, 133, 134 in physical space. The plurality of signal transmitting modules are respectively disposed in the plurality of devices 131, 132, 133, 134, in order to transmit and receive device data. The user interface 12 includes interface icon identifications corresponding to the device. Further, the plurality of devices 131, 132, 133, 134 may be individually or partly bound and connected by the interface icon identifications and the topological relation in the user interface.

In the embodiment of the present invention, the calculating unit may be combined with the user interface or separated from the user interface. Each device can transmit the device data with each other by the signal transmitting module. The topological relation includes a relative position relation of the plurality of devices in physical space, which is calculated by a calculating unit. The system for binding a plurality of devices using network topologies further includes a storage unit, which may store a relative position relation, device data, a look up table of the interface icon identifications and the corresponding device data. The device data includes physical device identifications or a network address. The interface icon identifications are corresponding to the physical device identifications, and can be automatically configured in the relative position of the user interface.

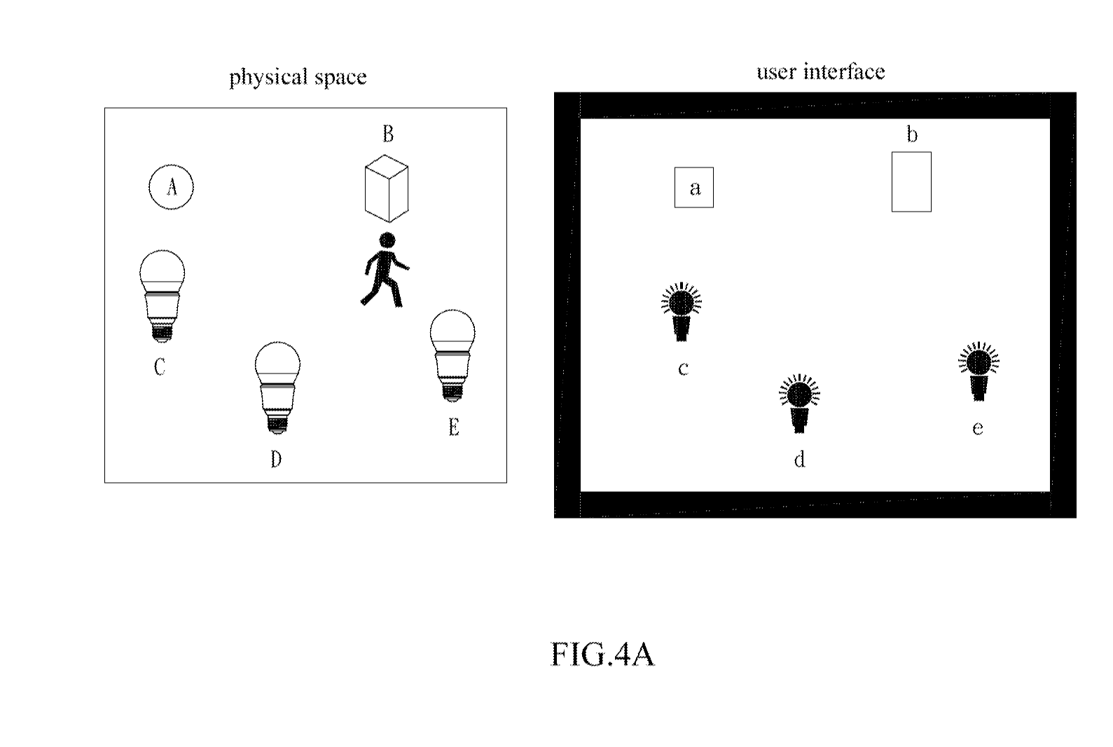

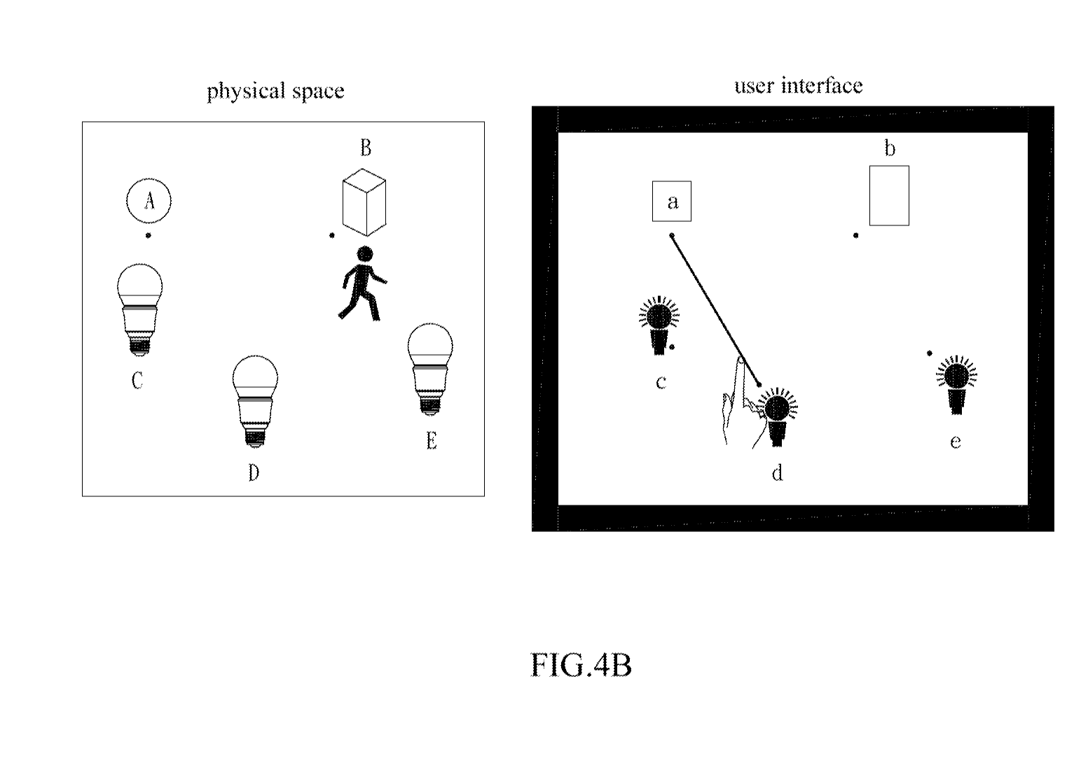

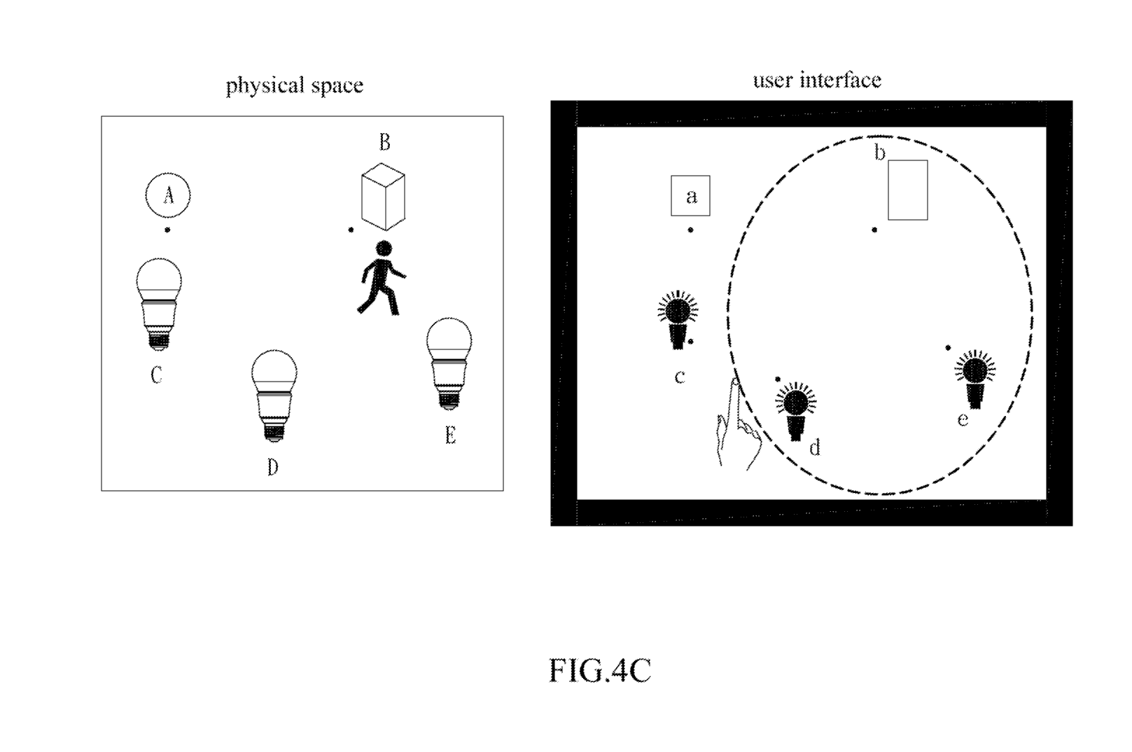

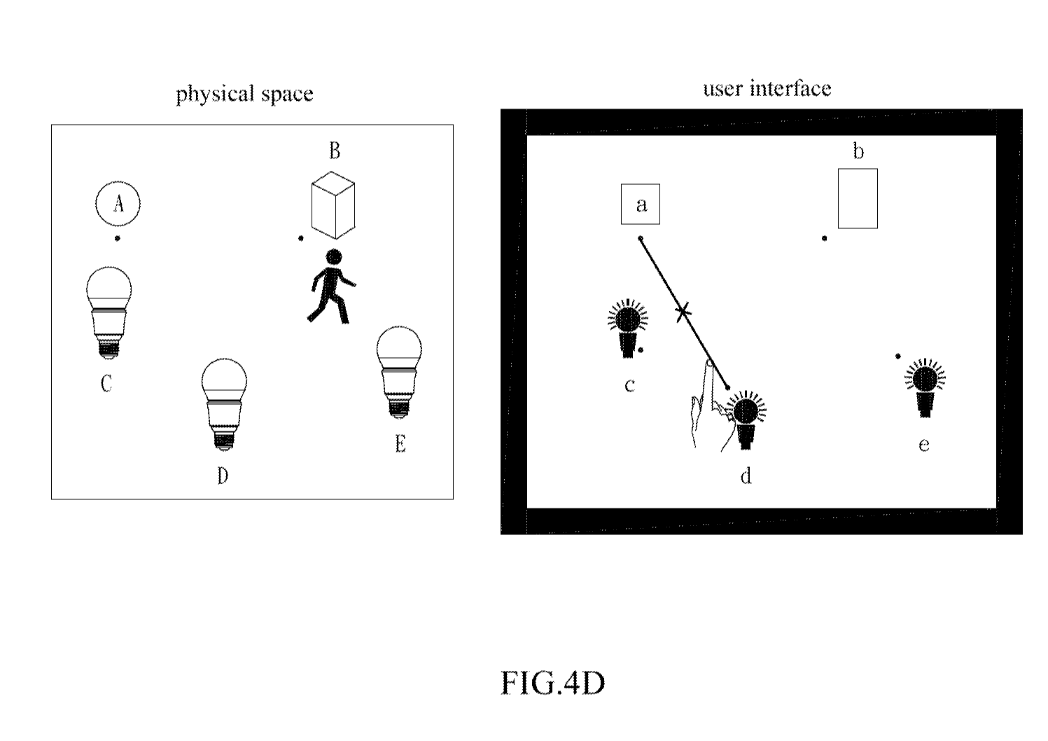

Referring to FIG. 4A to FIG. 4D, FIG. 4A to FIG. 4D illustrate views for binding devices by using network topologies according to an embodiment of the present invention. As shown in FIG. 4A, there are a switch A, a motion sensor B and lamps C, D, E in physical space. According to the method for binding devices by using network topologies of the present invention, switch A, motion sensor B and lamps C, D, E will transmit the signals with each other. When one of the devices receives the signal from another device, the received signal strength (RSS) of the signal, for example, will be recorded, and the signals will also be uploaded to the calculating unit. The calculating unit then may calculate a topological relation of each device, according to the uploaded signals, and display the relative position of each device in the user interface.

Interface icon identifications a, b, c, d, e in the user interface are respectively corresponding to devices A, B, C, D, E in physical space. Referring to FIG. 4B, if the user wants to control lamp D by switch A, the user may connect a line between interface icon identifications a, d in the user interface, so as to establish a binding between switch A and lamp D in physical space. Simultaneously, the user interface will transmit the connecting command, which is generated from the user interface, to the signal transmitting modules, and then the signal transmitting modules transmit the connecting command to switch A and lamp D in physical space. The binding between switch A and lamp D will be established. Therefore, when the user activates physical switch A, switch A will transmit a signal to lamp D in order to activate lamp D.

In addition, the user can connect or bind more than two devices at the same time. For example, lamps D, E can be connected or bound at the same time by sensor B. Referring to FIG. 4C, the user can circle sensor b and lamps d, e by drawing a circle in the user interface, so as to reach the purpose of binding the devices. At this moment, the user interface will transmit the different connecting commands to sensor B and lamps D, E, according to the device types of the devices. After sensor B receives the connecting command, the binding between sensor B and lamps D, E will be established. Thus, when sensor B senses the moving object, sensor B will transmit a signal to lamps D, E for activating lamps D, E.

Moreover, as shown in FIG. 4D, when the user wants to cancel the binding between the devices, the user can draw a cross between the connected interface icon identifications in the user interface, so as to cancel the binding. Then, the signal transmitting module of the user interface will transmit signals for canceling the connection to devices A, D, so the binding between devices A, D in physical space will be canceled.

The user can also establish a binding between the devices which have the same device type, in order to enable the devices do the same action simultaneously. For example, when the user wants device C to operate simultaneously with devices D, E, the user can draw a line from interface icon identification c to interface icon identifications d, e to establish the connection thereof. Then, the signal transmitting module of the user interface will transmit the connecting commands to lamps C, D, E, and devices C, D. E will exchange the signals for establish the binding thereof. Therefore, when the next time lamp C is activated, lamps D, E will be activated simultaneously. Although the lamps are illustrated in the embodiment, however the present invention is not limited thereto.

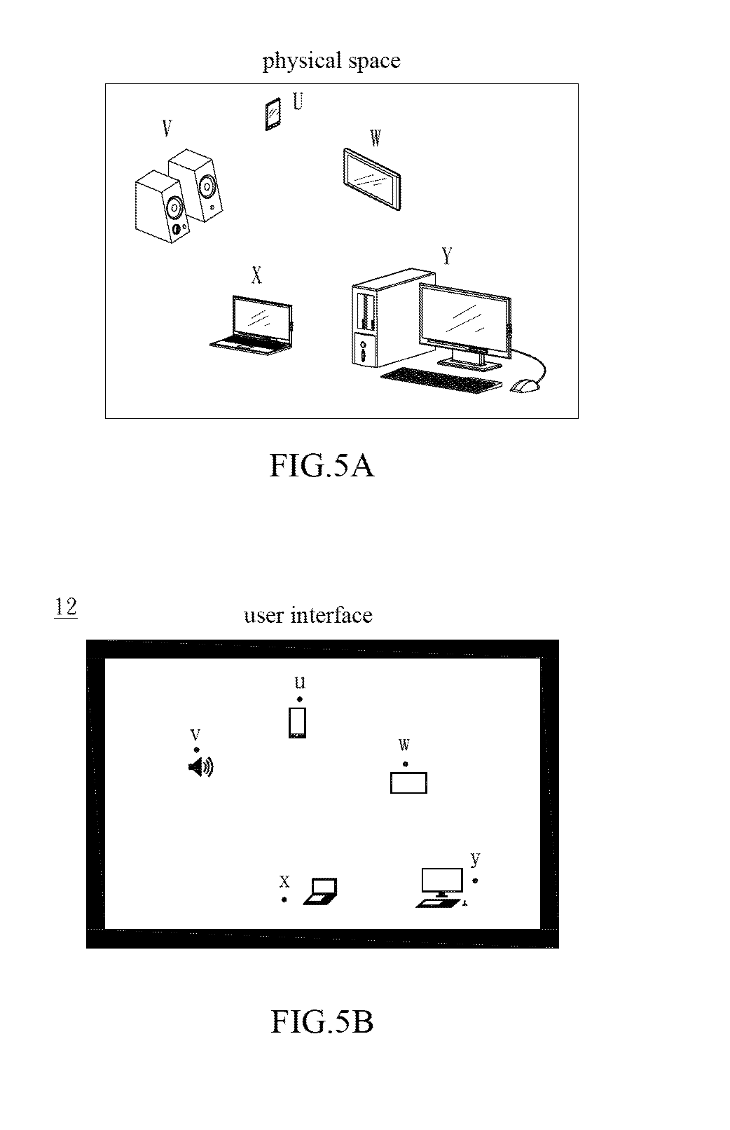

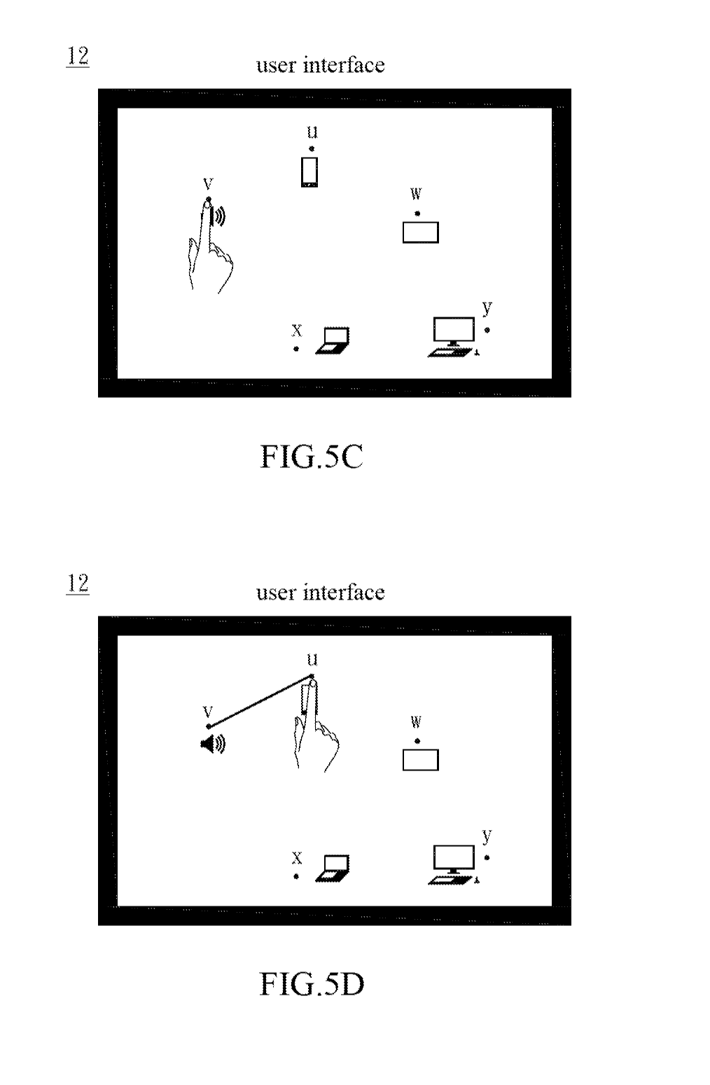

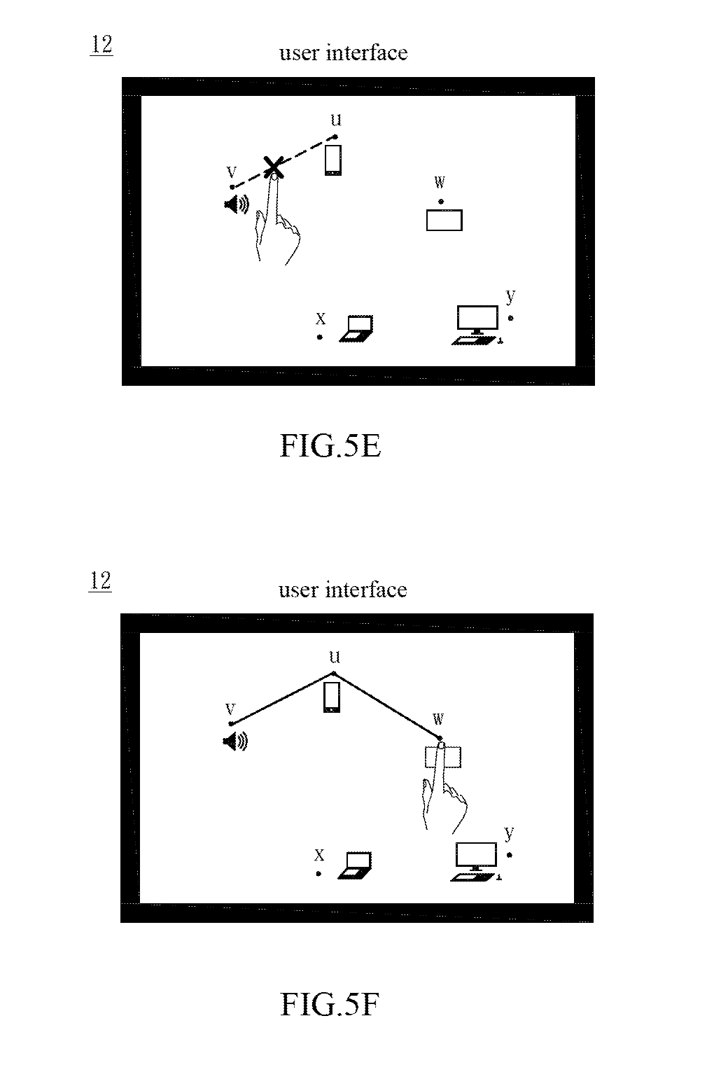

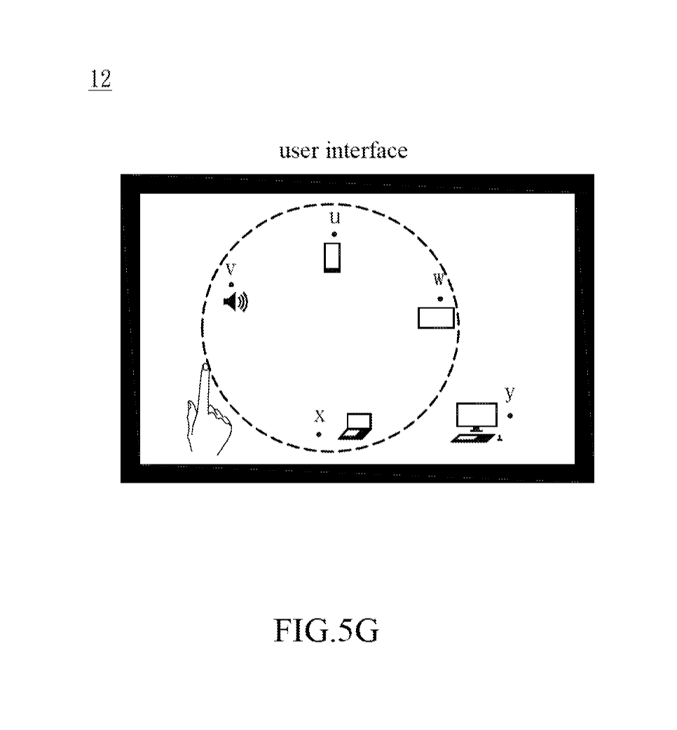

Referring to FIG. 5A and FIG. 5B, FIG. 5A and FIG. 5B illustrate views for binding the devices of different types by using network topologies, according to an embodiment of the present invention. In this embodiment, the devices in physical space of FIG. 5A include a smart phone U, a speaker V, a tablet computer W, a notebook computer X and a displayer, but the present invention is not limited thereto. As shown in FIG. 5B, interface icon identifications u, v, w, x, y corresponding to the device data are displayed in the user interface, so that the plurality of devices can be individually or partly disposed and connected by interface icon identifications u, v, w, x, y and the relative position in the user interface. The difference between the present embodiment and the above embodiment is that the devices of the present embodiment are unable to directly transmit the signals with each other. Therefore, in order to achieve the purpose of exchanging the signals, the system can have one or more gateways. Similarly, when the user performs the connecting operation mentioned above in the user interface, the signal transmitting module will transmit the signal to the corresponding device through the gateway, according to the interface icon identifications and the physical device identifications recorded in the look up table. After the device receives the connecting command, the device can establish a binding with another device through the gateway, or the device uploads the connecting command to the calculating unit and then the connecting command is transmitted to other gateways for the destination device by the signal transmitting modules.

FIG. 5C to FIG. 5G illustrate views for binding the devices by using network topologies according to the above embodiment of the present invention. Similarly, the devices will be individually or partly bound and connected by connecting a line or circling in the user interface, and the principle is similar to that of above embodiment, so the similarities are not repeated here.

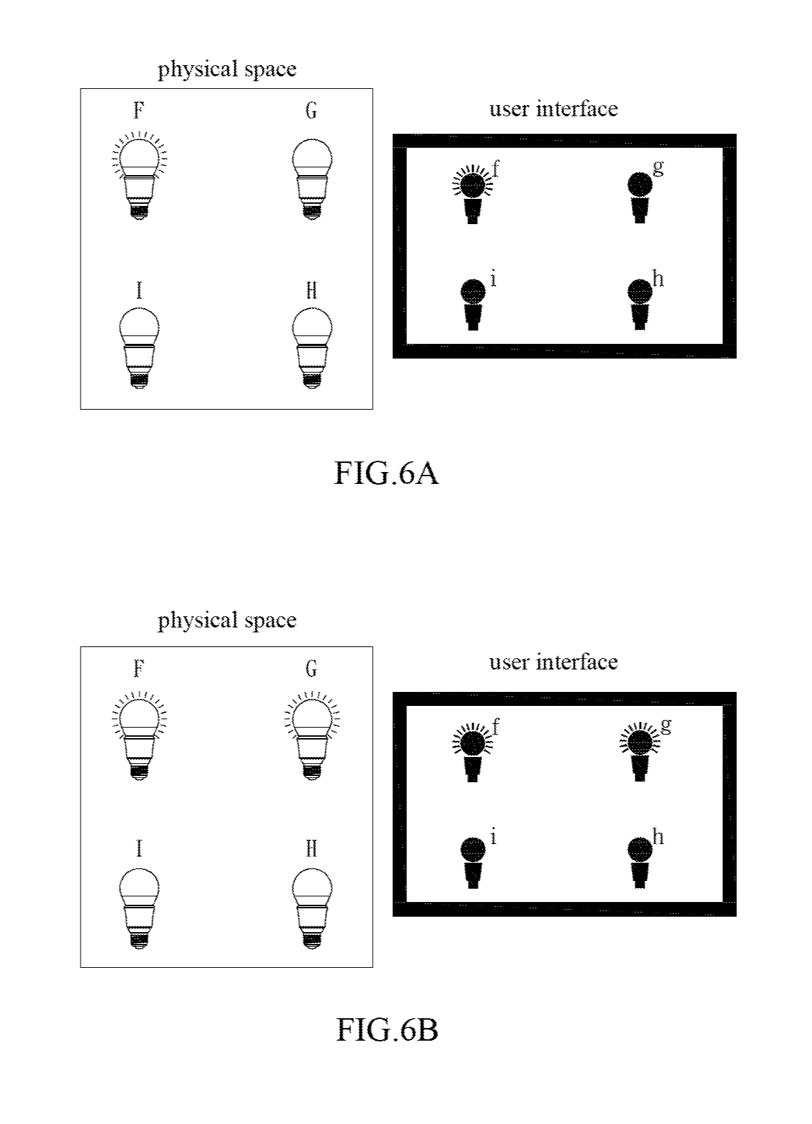

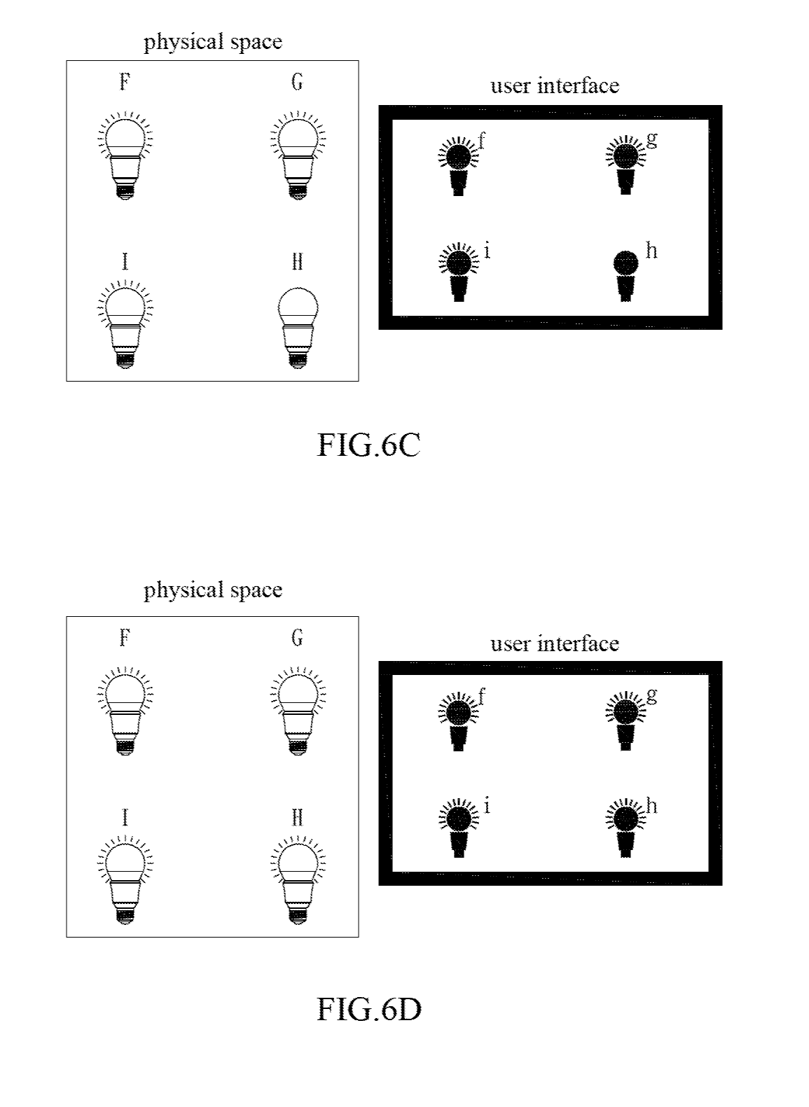

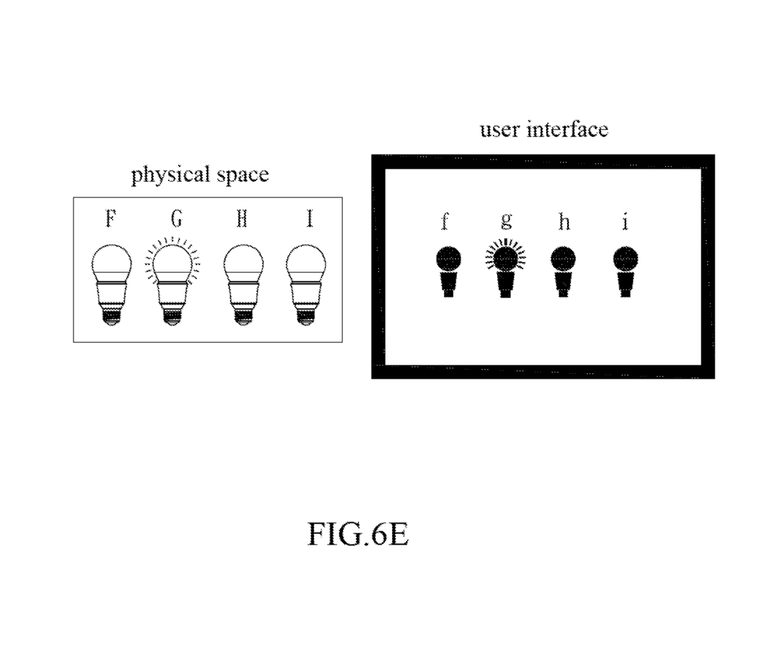

Referring to FIG. 6A to FIG. 6E, FIG. 6A to FIG. 6E illustrate views of the lamps being paired according to an embodiment of the present invention. This embodiment mainly illustrates how the system guides the user to pair the devices in physical space and the user interface, when the arrangement of the plurality of devices in physical space is a symmetrical arrangement that the user hardly distinguishes position relations of the devices in the user interface. The left side of FIG. 6A illustrates the arrangement of lamps F, G, I, H in physical, and the right side of FIG. 6A illustrates the arrangement of interface icon identifications f, g, i, h in the user interface. As the arrangement of lamps F, G, I, H in physical space is a symmetrical arrangement (the system is unable to directly and respectively connect lamps F, G, I, H to the corresponding interface icon identifications f, g, i, h in the user interface), the system will guide the user to pair the devices. Firstly, the system, according to the topological relation of devices, selects two devices which are not on the same symmetric line regarding to the topological relation of devices (For example, lamps f and g, which are both arranged at the same side). Then, as shown in FIG. 6A, the system will request the user to identify the first device, which the user regards as lamp f, by doing some specific actions (such as the action of activating the device), and for this embodiment it is the action of activating lamp F in physical space. Afterwards, as shown in FIG. 6B, the system will request the user to do the same action for the second lamp g, so that the user will activate lamp G in physical space. By confirming two lamps F and G, the system will figure out the only corresponding relation between lamps F, G, I, H and interface icon identifications f, g, i, h in the user interface, so that lamps I and H will be respectively corresponding to interface icon identifications i and h. Accordingly, the system can make the connection between the devices and the user interface and also establish the binding between the devices.

Moreover, referring to FIG. 6E, if lamps F, G, I, H are arranged in line, the system will select the device that can uniquely determine the topological relation of devices, which is lamp g, and request the user to activate lamp G in physical space. Then, by confirming lamp G, the system will figure out the only corresponding relation between lamps F, G, I, H and interface icon identifications f, g, i, h in the user interface.

In view of the foregoing, as for the method and system for binding a plurality of devices by using network topologies of the present invention, the devices are individually or partly bound and connected by the interface icon identifications in the user interface, which are corresponding to the topological relation of the devices in physical space. Compared with the prior art, the present invention can allow the user to complete the connection and arrangement of devices in a convenient, fast and intuitive way. Further, as the user can change the connection and arrangement of devices, the connection generated in the user interface may have greater flexibility in the design, so as to further reduce the arrangement cost, manpower and time in physical space.

What is claimed is:

1. A system for binding a plurality of devices using network topologies, comprising:
one or more calculating units, configured to calculate a topological relation of a plurality of devices in physical space;
a plurality of signal transmitting modules, separately disposed in the plurality of devices so that the signal transmitting modules transmit and receive device data and the topological relation of the plurality of devices; and
a user interface, comprising a set of interface icon identifications corresponding to the plurality of devices;
wherein the plurality of devices are individually or partly bound and connected by connecting the interface icon identifications in the user interface.

2. The system of claim 1, wherein the topological relation includes a relative position relation of the plurality of devices.

3. The system of claim 1, wherein the plurality of interface icon identifications are automatically configured according to the relative positions of devices in physical space.

4. The system of claim 1, further comprising a storage unit storing the relative positions, the device data and a look up table of the plurality of interface icon identifications.

5. The system of claim 1, wherein the device data includes a physical device identification (Hardware ID) or a network address.

6. The system of claim 5, wherein the plurality of interface icon identifications are corresponding to the physical device identifications.

7. A method for binding a plurality of devices using network topologies, comprising the following steps:
transmitting signals between the plurality of devices;
calculating a topological relation of the plurality of devices in physical space according to the signals;
displaying the plurality of devices in a user interface with a plurality of interface icon identifications based on their physical topology, wherein the plurality of interface icon identifications individually correspond to the plurality of devices;
connecting the plurality of interface icon identifications in the user interface;
transmitting connecting commands of the plurality of interface icon identifications to the corresponding devices; and
binding the plurality of devices according to the received connecting commands.

8. The method of claim 7, further comprising the steps of collecting and storing the signals.

9. The method of claim 7, the signals are used to calculate a relative position of the plurality of devices in physical space.

10. The method of claim 9, wherein an arrangement of the plurality of interface icon identifications in the user interface is the same as the topological relation of the plurality of devices in physical space.

11. The method of claim 7, wherein the plurality of devices include device data, and the device data includes a physical device identification (Hardware ID) or a network address.

12. The method of claim 11, further comprising a step of recording the plurality of interface icon identifications and the physical device identifications in a look up table.

13. The method of claim 12, wherein the plurality of interface icon identifications are corresponding to the physical device identifications.

14. The method of claim 13, wherein the connecting commands are transmitted to the corresponding devices, according to the plurality of interface icon identifications and the physical device identifications of the look up table.

15. The method of claim 7, wherein the step of connecting the plurality of devices further includes connecting or circling the plurality of devices.

16. The method of claim 7, wherein the topological relation is calculated by a calculating unit.
